(19) United States
(12) Patent Application Publication
(10) Pub. No.: US 2009/0183540 A1
(43) Pub. Date: Jul. 23, 2009

(54) PICKUP-TRUCK TAILBOARD LOCK

(76) Inventor: Chien-Chih LU, Kansan Township (TW)

Correspondence Address: SINORICA, LLC, 2275 Research Blvd., Suite 500, ROCKVILLE, MD, 20850, US

(21) Appl. No.: 12/016,975

(22) Filed: Jan. 18, 2008

(51) Int. Cl. E05B 65/12

(52) U.S. Cl. 70/237

(57) ABSTRACT

A tailboard lock includes a main body having one side bored with two insert holes and a lateral hole crossing with the insert holes, a lock core received in the main body and having one end combined with interacting engage members, a positioning casing provided with a cover with a slide lid, a shackle having two rods connected by a curved member and having their inner surface cut with plural fitting notches, and a protective cover covered around the positioning casing and the cover. In using, the shackle is fitted around the pivot of a pickup-truck tailboard, and after the tailboard is pivotally assembled on the truck body, the two rods are inserted in the insert holes of the main body. Then, the lock core is turned to have the interacting engage members extended to fitting in one of the fitting notches of the lock rods, thus firmly locking the tailboard.

### BACKGROUND OF THE INVENTION

1. Field of the Invention

This invention relates to a lock, particularly to one used for locking the tailboard of a pickup truck.

2. Description of the Prior Art

A pickup truck is conveniently and widely employed for carrying people or goods. The pickup truck has its rear side provided with a movable blocking tailboard able to be disassembled or assembled for facilitating moving and transporting goods.

However, the movable tailboard of a pickup truck is likely to cause shifting or even falling off when the pickup truck runs and sways violently on an uneven road or when a user pulls and opens the tailboard. In addition, the tailboard of a pickup truck is made of sheet metal and it is also a universal vehicle part; therefore, the tailboard is likely to be detached and stolen by burglars and resold for obtaining profits.

### SUMMARY OF THE INVENTION

The objective of this invention is to offer a lock simple in structure and able to be firmly locked on a detachable tailboard combined at the rear side of a pickup truck in order to prevent the tailboard from being loosened and falling off when it is pulled and opened, or protect the tailboard from being detached and burgled.

The pickup-truck tailboard lock in the present invention includes a lock main body, a lock core, a positioning casing, a shackle and a protective cover. The lock main body is formed with an accommodating groove in the interior and has one side axially bored with two through insert holes and two lateral holes crossing with the two through insert holes. The lock core with any shape and having locking and unlocking function is received in the accommodating groove of the lock main body and fixed therein by a fixing ring, and having its outer end bored with a key hole and its inner end provided with two interacting engage members extended in the lateral holes of the lock main body. The positioning casing to be covered around the lock main body has its opening disposed with a cover bored with a key insert slot communicating with the outside at a location matching with the key hole of the lock core. The key insert slot is disposed with a slide lid able to be slidably opened and closed. The shackle is formed with two parallel rods having their outer ends connected by a curved member made of flexible metal sheet and has their inner surfaces respectively cut with a plurality of lengthwise fitting notches. The protective cover is to be covered on both the positioning casing and the cover.

In using, the shackle of the tailboard lock is first fitted around the pivot of a pickup-truck tailboard, and after the tailboard is pivotally combined with the truck body, the lock core is turned to position in an unlocked state to let its interacting engage members retracted and positioned in the interior of the lateral holes. Next, the two parallel rods of the shackle are inserted in the two insert holes of the lock main body, and then according to the outer diameter size of the pivot, select one of the fitting notches of the two rods and have them aligned to the lateral holes of the lock main body. Subsequently, the lock core is turned to position in a locked state to let its interacting engage members extended out of the lateral holes to fit in one of the fitting notches of the two rods. Lastly, the slide lid of the cover is slidably shifted to close the key insert slot, and the protective cover is covered around the tailboard lock to finish installing the tailboard lock on the pickup-truck tailboard.

As can be understood from the above description, this invention has the following efficacies.

1. The tailboard lock of this invention can surely prevent a tailboard pivotally combined with a pickup truck from falling off.

2. The tailboard lock of this invention can effectively protect the tailboard from being detached and burgled.

3. The slide lid of the cover is able to prevent rain water and dust from getting into the interior of the lock core through the key insert slot to influence locking and unlocking efficacy of the lock.

4. The protective cover can prevent the main body of the tailboard lock from directly contacting with external objects and also avoid the tailboard lock body directly colliding with the truck body and causing damage.

### BRIEF DESCRIPTION OF DRAWINGS

FIG. 1 is a perspective view of a pickup truck tailboard lock in the present invention;

FIG. 2 is exploded perspective view of the pickup truck tailboard lock in the present invention;

FIG. 3 is a perspective view of a pickup truck assembled thereon with a tailboard provided with the lock in the present invention;

FIG. 4 is a side view of the pickup truck assembled thereon with the tailboard in the present invention; and

FIG. 5 is a side view of the tailboard lock locked on the pickup truck tailboard in the present invention.

### DETAILED DESCRIPTION OF THE PREFERRED EMBODIMENT

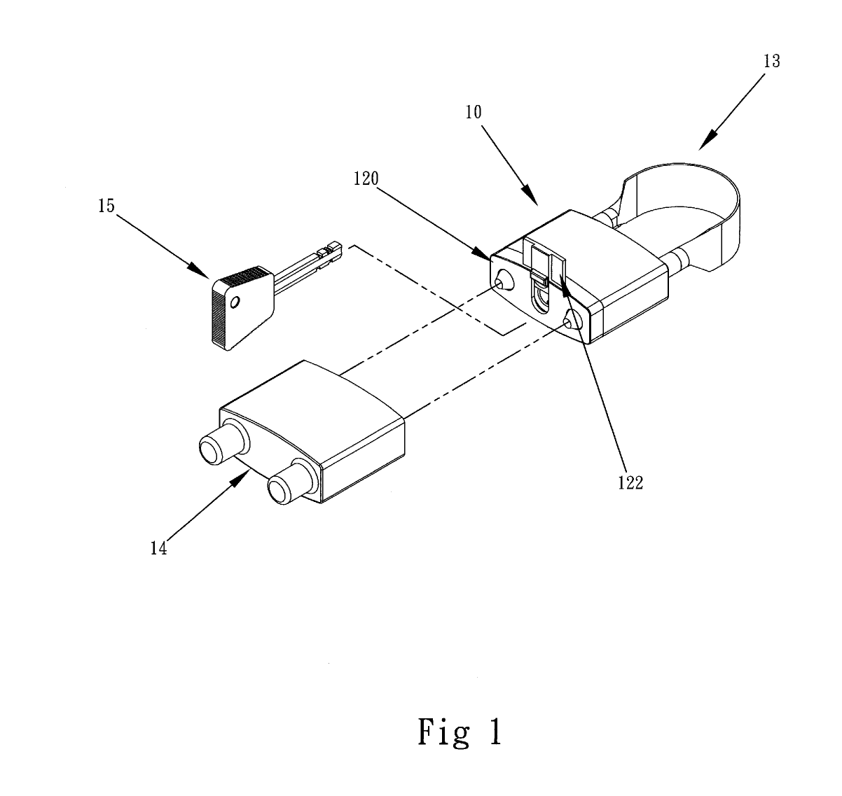

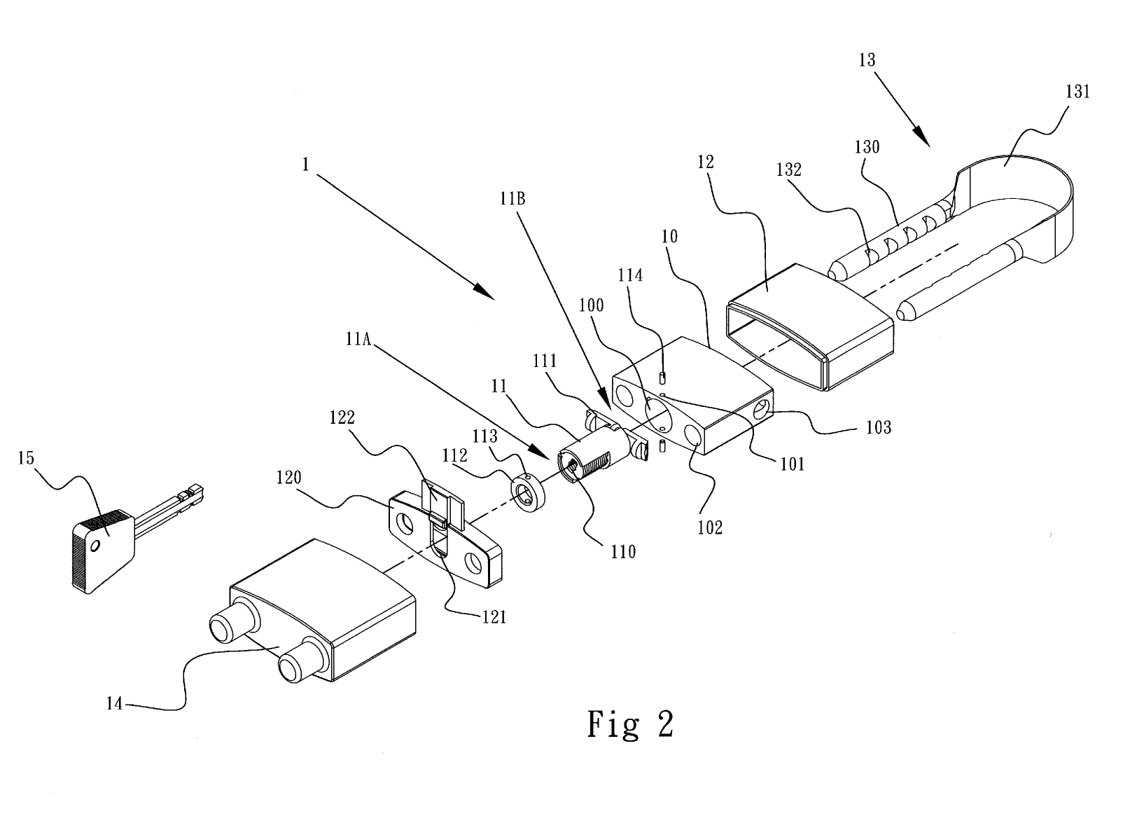

A preferred embodiment of a pickup truck tailboard lock in the present invention, as shown in FIGS. 1 and 2, includes a lock main body 10, a lock core 11, a positioning casing 12, a clasping member 13 and a protective cover 14 combined together.

The lock main body 10 is a metallic block body having its interior bored with an accommodating groove 100 having two pin holes 101 symmetrically bored near its opening. The lock main body 10 further has one side axially bored with two through insert holes 102 at two sides of the accommodating groove 100, and crossing with the insert holes 102 is formed a lateral hole 103 at a rear portion.

The lock core 11 with any shape and having locking and unlocking function is received in the accommodating groove 100 of the lock main body 10 to be rotatably positioned therein. The lock core 11 had its first end 11A bored with a key hole 110 and its second end 11B provided with two interacting engage members 111 to be respectively extended in the lateral hole 103 of the lock main body 10. A fixing ring 112 bored with two opposite insert holes 113 is to be fixed at the opening of the accommodating groove 100, and two insert pins 114 are respectively inserted in both the pin holes 101 of the lock main body 10 and the insert holes 113 of the fixing ring 112 for positioning the fixing ring 112 and securing the lock core 11 in the accommodating groove 100 of the lock main body 10.

The positioning casing 12 is to be covered around the lock main body 10 for protecting the lock main body 10 and stopping the insert pins 114 from slipping off the pin holes 101. The positioning casing 12 has its opening combined with a cover 120 bored with a key insert slot 121 communicating with the outside and matching with the key hole 110 of the lock core 11, and a slide lid 122 able to be slidably opened and closed is disposed at the key insert slot 121 of the positioning casing 12.

The shackle 13 is formed with two parallel rods 130 having their outer ends connected by a curved member 131 made of a flexible metal sheet and their inner surface respectively cut with a plurality of fitting notches 132 spaced apart and arranged longitudinally. Thus, after inserted in the insert holes 102 of the lock main body 10, the two rods 130 can be respectively engaged with the two engage members 111 of the lock core 11 fitting in one of the fitting notches 132.

The protective cover 14 made of rubber is to be covered around both the positioning casing 12 and the cover 120 of the tailboard lock 1.

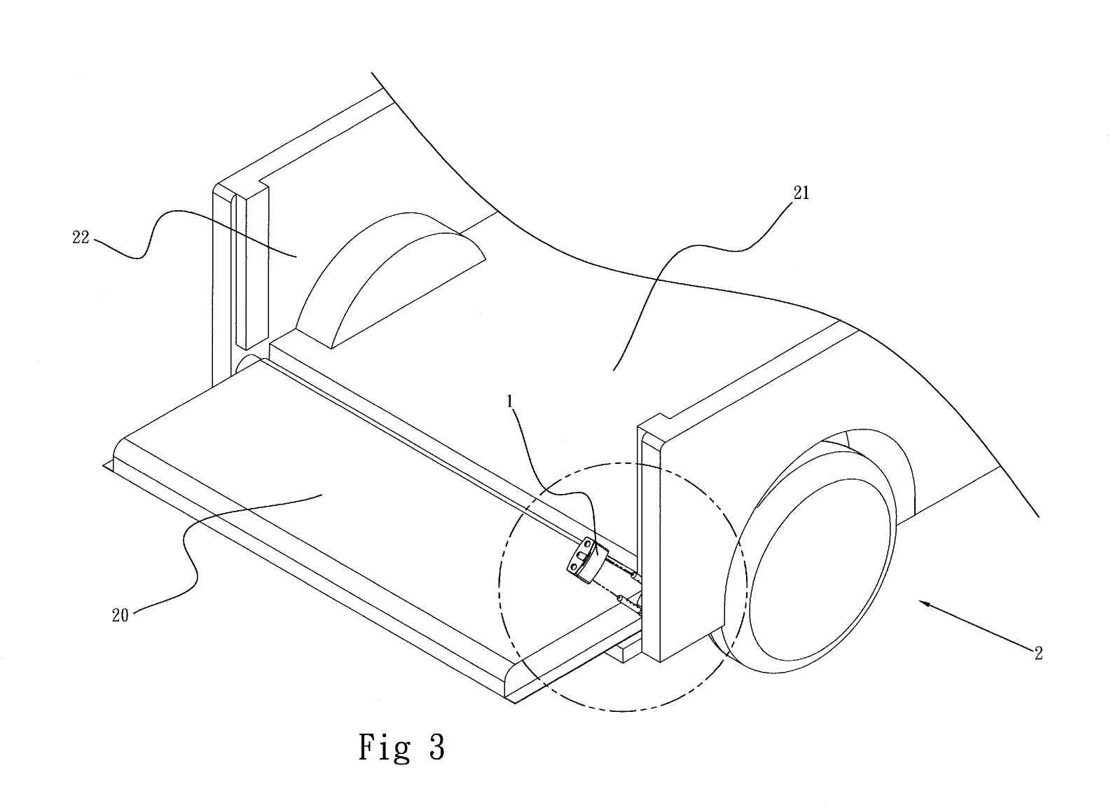

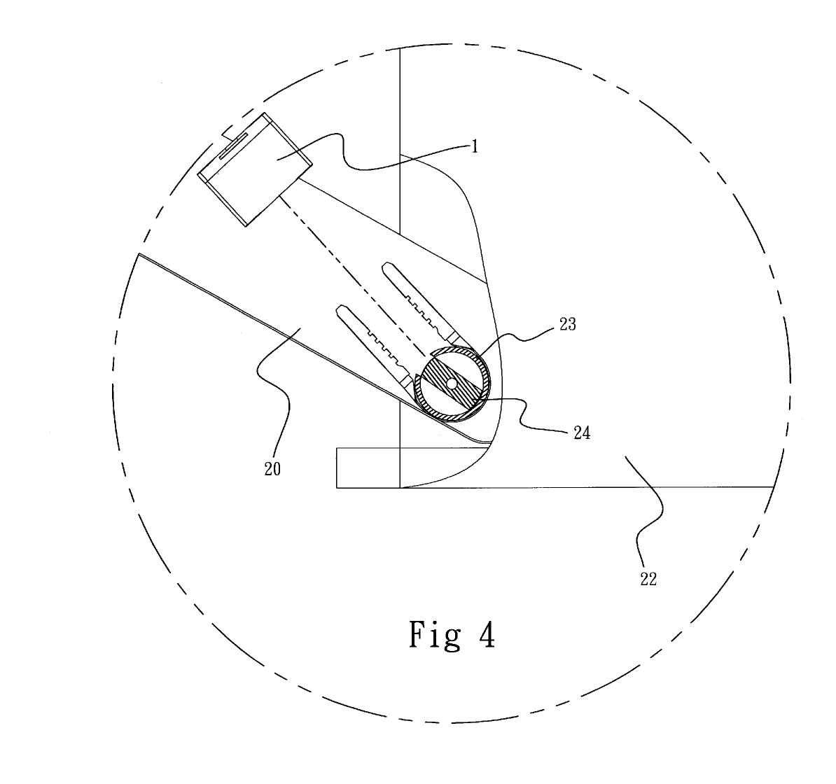

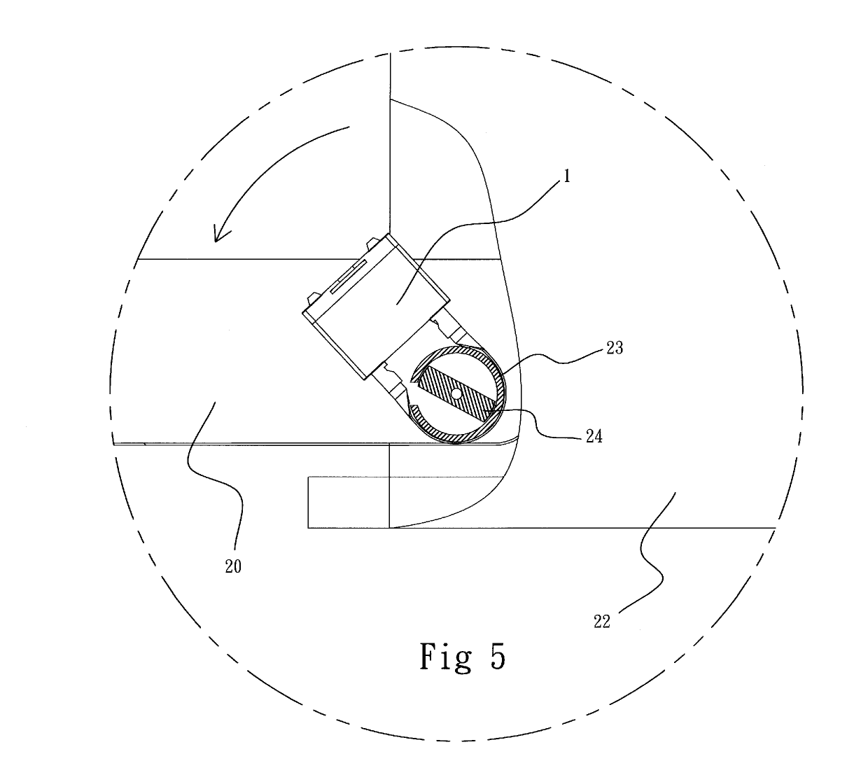

FIGS. 3, 4 and 5 respectively show that the tailboard lock is installed on a pickup truck and the pickup truck is assembled thereon with a tailboard.

The tailboard lock 1 of this invention is mainly used for a pickup truck 2, which has the rear portion provided with a stowage board 21 having its opposite sides respectively disposed with a separating board 22 and its rear side assembled with a detachable and movable tailboard 20 and respectively perpendicular to the stowage board 21. Each separating board 22 has one lower inward side (or the tailboard 20 has its lower opposite corners) extended to form a C-shaped pivot 23 with a hollow receiving space in the interior, and the C-shaped pivot 23 has its surface cut with an axial opening communicating with the interior receiving space. The tailboard 20 has a portion corresponding with the bottom of the separating board 22 (or the separating board 22 has a portion corresponding with the lower opposite corners of the tailboard 20) extended and provided with a solid pivot 24 formed axially with two lengthwise flat surfaces parallel and symmetrical to each other. The rectilinear distance between the two flat surfaces is somewhat shorter than width of the opening of the C-shaped pivot 23, and the two flat surfaces are positioned at a specific angle relative to a vertical direction of the stowage board 21.

To assemble the tailboard 20 on the pickup truck, the tailboard 20 is positioned at a specific angle to enable its solid pivot 24 (or its C-shaped pivot 23 opening) to be aligned to the C-shaped pivot 23 opening (or the solid pivot 24) of the separating board 22, letting the flat surface of the solid pivot 24 aligned to the opening of the C-shaped pivot 23 and then actuated to slide into the receiving space of the C-shaped pivot 23 to be positioned therein. Then, the tailboard 20 is swung to change its angle to avoid the flat surface of the solid pivot 24 being aligned to the C-shaped pivot 23 opening and slipping off the C-shaped pivot 23, thus finishing positioning the tailboard 20 on the pickup truck.

To have the tailboard lock 1 of this invention locked on the tailboard 20 of the pickup truck, firstly, the shackle 13 is fitted around the C-shaped pivot 23 on the separating board 22 (or on the tailboard 20), and after the C-shaped pivot 23 and the solid pivot 24 are fixed in position, the curved member 131 of the shackle 13 is closely clamped on the outer side of the C-shaped pivot 23, letting the two rods 130 positioned in a parallel state and the shackle 13 become U-shaped. Next, a key 15 is inserted in the key hole 110 of the lock core 11 and turned around to let the lock core 11 position in an unlocked state and its interacting engage members 111 retracted and positioned in the lateral hole 103, and then the two lock rods 130 of the shackle 13 are respectively inserted in the two insert holes 102 of the lock main body 10. Simultaneously, according to the outer diameter size of the C-shaped pivot 23, select one of the fitting notches 132 at the opposite inner sides of the two rods 130 and have them aligned to the lateral hole 103 in the insert holes 102 for adjusting a clamping range of the tailboard lock 1. Afterward, the lock core 11 is turned around to position in the locked state to let its interacting engage members 111 respectively extended out of the lateral hole 103 and fitting in one of the fitting notches 132 of the two rods 130. Lastly, the slide lid 122 of the cover 120 is slidably shifted to close up the key insert slot 121 and the protective cover 14 is covered around the tailboard lock 1, thus finishing installing the tailboard lock 1 on the tailboard 20 of a pickup truck.

To sum up, this invention has the following advantages.

1. The tailboard lock clamped around the C-shaped pivot can surely block off the opening of the C-shaped pivot and effectively prevent the tailboard pivotally assembled on the pickup truck from falling off and also protect the tailboard from being detached and burgled.

2. The slide lid of the cover can function to stop rain water or dust from getting into the interior of the lock core through the key insert slot and affecting locking and unlocking function of the tailboard lock.

3. The protective cover is able to prevent external objects from directly touching the main body of the tailboard lock and also avoid the tailboard lock directly colliding with the truck body and causing damage after the tailboard lock is installed on the tailboard of the pickup truck.

While the preferred embodiment of the invention has been described above, it will be recognized and understood that various modifications may be made therein and the appended claims are intended to cover all such modifications that may fall within the spirit and scope of the invention.

I claim:

1. A tailboard lock for locking a detachable tailboard on a pickup truck, said lock comprising:
a lock main body formed with an accommodating groove in the interior, said lock main body having one side axially bored with two through insert holes at two sides of said accommodating groove, a lateral hole formed to cross said two insert holes at their rear portion;
a lock core received in said accommodating groove of said lock main body to be rotatably positioned therein, said lock core having its first end bored with a key hole and its second end disposed with two interacting engage members, said engage members extended in said lateral hole of said lock main body, said accommodating groove having its opening fitted with a fixing ring;
a positioning casing covered around said lock main body, said positioning casing having its opening fitted with a cover, said cover bored with a key insert slot at a location matching with said key hole of said lock core, said key insert slot provided with a slide lid able to be slidably opened and closed;
a shackle formed with two parallel rods, said two rods having their outer ends connected by a curved member, said two rods having their inner surface cut with a plurality of one-way lengthwise fitting notches; and
a protective cover covered around said positioning casing and said cover.

2. A tailboard lock as claimed in claim 1, wherein said pickup truck is formed with a truck body having its rear side provided a stowage board, which has its opposite sides respectively disposed thereon with a separating board perpendicular to said stowage board and its rear side vertically assembled with a detachable tailboard, each said separating board having one lower inner side (or said tailboard having its lower opposite corners) extended to form a C-shaped pivot, said C-shaped pivot having its interior formed with a receiving space and its surface cut with an axial opening communicating with said receiving space, said tailboard having a portion corresponding with a bottom of said separating board (or said separating board having a portion corresponding with said opposite corners of said tailboard) extended to form a solid pivot matching with said C-shaped pivot, said solid pivot axially provided with two parallel and symmetrical flat surfaces, a rectilinear distance between said two flat surfaces being somewhat shorter than a width of said opening of said C-shaped pivot, said two flat surfaces provided at a specific angle relative to a vertical direction of said stowage board.

3. The tailboard lock as claimed in claim 1, wherein said lock core can be of any locking mode.

4. The tailboard lock as claimed in claim 1, wherein said curved member of said clamping member is sheet-shaped.

5. The tailboard lock as claimed in claim 1, wherein said protective cover is made of rubber.
